(19) United States
(12) Patent Application Publication
(10) Pub. No.: US 2002/0163543 A1
(43) Pub. Date: Nov. 7, 2002

(54) Menu item selection method for small-sized information terminal apparatus

(76) Inventor: Minoru Oshikiri, Hamamatsu-shi (JP)

Correspondence Address: Pillsbury Winthrop LLP, Intellectual Property Group, Suite 2800, 725 South Figueroa Street, Los Angeles, CA, 90017-5406, US

(21) Appl. No.: 10/136,788

(22) Filed: May 1, 2002

(30) Foreign Application Priority Data
May 2, 2001 (JP) 2001-135254
Jun. 19, 2001 (JP) 2001-184557

(51) Int. Cl. G09G 5/00

(52) U.S. Cl. 345/810

(57) ABSTRACT

Menu items are displayed on a display section, along with a cursor sequentially designating the individual menu items in a cyclic fashion. A guide sound, such as a pip, may be audibly generated each time the cursor moves to designate any one of the menu items. User can select a desired one of the menu items by depressing a selection button while the desired menu item is being designated by the cursor. Down and up arrow buttons are assigned to function as jump buttons, and each of the down and up arrow buttons is operable to move the cursor downwardly or upwardly, one menu item per depression of the button. Each of right and left arrow buttons is operable to move the cursor downwardly or upwardly, two or more menu items per depression of the button. There may be provided dedicated jump buttons separate from the down and up arrow buttons.

### BACKGROUND OF THE INVENTION

The present invention relates to menu item selection methods for use with small-sized information terminal apparatus such as mobile or cellular phones. More particularly, the present invention relates to an improved method for selecting a desired one of three or more menu items with ease, as well as a small-sized information terminal apparatus, such as a mobile or cellular phone, employing such an improved menu item selection method.

There have heretofore been known various menu item selection methods for use with mobile or cellular phones, among which are ones shown in FIGS. 13 and 14. The menu item selection method of FIG. 13 is suitable for use, for example, in a cellular phone of a type as shown in FIG. 2, in accordance with which a desired one of a plurality of menu items (ITEM 1 to ITEM 5) visually displayed on a display section (22A in FIG. 2) is selected by activating or operating the cursor-moving buttons, a down arrow button (DB) for forward moving or up arrow button (UB) for backward moving as necessary to place a cursor (CS) on the desired menu item and then depressing a selection button (SB). Namely, on selection screen P1 displayed with the cursor CS designating ITEM 1, a user can select ITEM 1 by activating or operating the selection button (SB). If the down arrow button (DB) is depressed once while such selection screen P1 is being displayed, selection screen P1 is replaced by selection screen P2 with the cursor CS designating ITEM 2 so that ITEM 2 can be selected by the user activating the selection button (SB).

Then, if the down arrow button (DB) is depressed once while such selection screen P2 is being displayed, selection screen P2 is replaced by selection screen P3 with the cursor CS designating next ITEM 3 so that ITEM 3 can be selected by the user operating the selection button (SB). Then, depressing the down arrow button (DB) once again while selection screen P3 is being displayed can switch the displayed screen over to selection screen P4 with the cursor CS designating next ITEM 4 so that ITEM 4 can be selected by the user activating the selection button (SB). After that, depressing the down arrow button (DB) once more while selection screen P4 is being displayed can switch the displayed screen over to selection screen P5 with the cursor CS designating ITEM 5 or RETURN. While such selection screen P5 is being displayed on the display section, activation, by the user, of the selection button SB can display a menu screen of a higher hierarchical level—from which the menu screen of FIG. 13 was called up—within a hierarchical (tree-like) organization of menu screens as shown in FIG. 15. If the up arrow button (UB) is depressed once while selection screen P5 is being displayed, the displayed screen can be switched over to selection screen P4 again to allow the user to select ITEM 4.

The menu item selection method of FIG. 14 is directed to allowing the user to select a desired menu item on selection screen P1 by depressing a numeric button corresponding to the desired menu item. For example, ITEM 4 can be selected by depressing numeric button “4”.

FIG. 16 shows another example of the conventionally-known menu item selection method, which is suitable for use, for example, in a cellular phone of a type as shown in FIG. 7, according to which a desired one of a plurality of menu items (in this case, ITEM 1 to ITEM 8) visually displayed on the display section (22A′0 in FIG. 7) is selected by activating or operating the down arrow button (DB) for forward moving or up arrow button (UB) for backward moving as necessary to place the cursor (CS) on the desired menu item and then depressing the selection button (SB). As seen from the figure, this menu item selection method operates generally in a similar manner to the method illustrated in FIG. 13. Namely, when ITEM 6 is to be selected on selection screen P1 with the cursor CS designating ITEM 1, and if the down arrow button (DB) is depressed once, the displayed screen is switched over to selection screen P2 with the cursor CS designating ITEM 2. Likewise, depressing the down arrow button (DB) once while selection screen P2 is being displayed, the displayed screen is switched over to selection screen P3 with the cursor CS designating ITEM 3. Performing similar depressing operation of the down arrow button (DB) three more times, the displayed screen is switched, by way of selection screens P4 and P5, over to selection screen P6 with the cursor CS designating ITEM 6. Then, using such selection screen P6 with the cursor CS designating ITEM 6, the user can select ITEM 6 by activating the selection button (SB) once.

Further, when ITEM 6 is to be selected on selection screen P1 with the cursor CS designating ITEM 1, and if the up arrow button (UB) is depressed once, selection screen P1 is replaced with selection screen P8 with the cursor CS designating ITEM 8, as illustratively shown in FIG. 17. Performing similar depressing operation of the up arrow button (UB) two more times, the displayed screen is switched, by way of selection screens P7, over to selection screen P6 with the cursor CS designating ITEM 6. Then, using such selection screen P6 with the cursor CS designating ITEM 6, the user can select ITEM 6 by activating the selection button (SB) once.

The menu item selection method of FIG. 18 is directed to allowing the user to select a desired menu item on selection screen P1 by depressing a numeric button corresponding to the desired menu item, in a similar manner to the above-discussed selection method of FIG. 14. Namely, when ITEM 6 is to be selected, the user depresses a numeric button “6” once.

However, according to the menu item selection methods of FIGS. 13, 16 and 17, the arrow button DB or UB has to be operated a plurality of times in order to move the cursor to a desired menu item; particularly, for selection of a menu item in a lower area of the menu showing many menu items as above, it is necessary to depress the arrow button DB or UB many times. Namely, these menu item selection methods would not allow the user to select a desired menu item with ease. The menu item selection methods illustrated in FIGS. 14 and 18 allow the user to select a desired menu item with only one button operation; however, in a case where the user performs menu item selecting operation with only his or her thumb while at the same time holding the cellular phone with one hand, it is often necessary for the user to depress a predetermined numeric button with the finger bent awkwardly and uncomfortably while ascertaining the position of the predetermined numeric button in the lower area of the phone. Thus, the menu item selection methods of FIGS. 14 and 18 too would not allow the user to select a desired menu item with ease. Further, these conventional menu item selection methods can not be applied to a menu having a greater number of menu items than the numeric buttons (e.g., ten numeric buttons in the example of FIG. 7 ) provided on the body of the cellular phone.

### SUMMARY OF THE INVENTION

In view of the foregoing, it is an object of the present invention to facilitate or simplify necessary menu item selecting operation in small-sized information terminal apparatus such as mobile or cellular phones.

It is another object of the present invention to provide an improved or novel menu item selection method and small-sized information terminal apparatus which allow a user to readily select a desired menu item with simple operation.

According to one aspect of the present invention, the present invention provides a menu item selection method for use with a small-sized information terminal apparatus including a display section and a selection button, which method comprises: a step of displaying a plurality of menu items on the display section; a step of displaying a cursor on the display section in such a manner that the cursor sequentially designates individual ones of the menu items in a cyclic fashion; a step of detecting whether the selection button has been operated while any one of the plurality of menu items is being designated by the cursor; and a step of selecting the menu item being designated by the cursor, in response to detection, by the step of detecting, operation of the selection button.

According to the menu selection method arranged as above, the individual menu items are designated by the cursor sequentially in a cyclic fashion on the display section. When a user activates the selection button while a desired one of the plurality of menu items is being designated by the cursor, the activation of the selection button is detected by the detecting step, in response to which the desired menu item being designated by the cursor is selected. As a consequence, the present invention allows the user to readily select any desired menu item by only activating the selection button once, and hence can significantly simplify the necessary menu item selecting operation.

According to the menu selection method of the present invention, guide sounds, such as pips, may be audibly generated as the menu items are designated by the cursor sequentially one by one. In this case, the user can select any desired menu item, for example, by counting the audibly generated guide sounds, so that the selecting operation by the user can be simplified even further. It is preferable that, for each of the menu items, the generation of the corresponding guide sound be initiated with a delay of a predetermined time behind predetermined display start timing of the cursor for that menu item. The reason why the timing to generate the guide sound is delayed behind the cursor display start timing for each of the menu items is that the user may activate the selection button slightly before the generation of the guide sound is initiated and, if the generation of the guide sound is set to start simultaneously with the cursor display start timing, the user may end up in failing to appropriately select a desired menu item due to his or her too-early activation of the selection button. Setting the generation start timing of the guide sound to be slightly later than the corresponding cursor display start timing in the above-mentioned manner can effectively avoid such failure in menu item selection.

According to another aspect of the present invention, there is provides a menu item selection method which comprises: a step of displaying first to Nth (N≧3) menu items on a display section in order of menu item numbers (i.e., in the mentioned order), as well as a cursor for designating any one of the menu items; a first movement step of, each time a first operator is operated or activated, moving the cursor, in a predetermined direction along an arrangement of the first to Nth menu items, so as to designate the menu item displayed next to the menu item currently designated by the cursor; a second movement step of, each time a second operator is activated, moving the cursor, in the predetermined direction, to designate the menu item displayed a predetermined number nj (nj≧2) of menu items ahead of the menu item currently designated by the cursor; a step of detecting whether a selection button has been activated while any one of the first to Nth menu items is being designated by the cursor; and a step of selecting the menu item being designated by the cursor, in response to detection, by the step of detecting, activation of the selection button.

In the present invention thus arranged, there can be used either one of a first operation mode where the cursor is moved one menu item per activation of the first operator and a second operation mode where the cursor is move, per activation of the second operator, to designate the menu item displayed the predetermined number nj of menu items away from the menu item currently designated by the cursor. With such arrangements, the present invention can reduce the necessary number of operations of the operators and thus allows the user to select a desired menu item with simpler operation and with increased ease.

In an embodiment of the second-aspect menu item selection method, the predetermined direction is a direction from the first menu item toward the Nth menu item. When the first operator is activated while the cursor is designating the Nth menu item, the first movement step moves the cursor to designate the first menu item. When the second operator is activated while the cursor is designating any one of the menu items within a range from the Nth menu item to the menu item displayed a predetermined number k (k=nj−1) of menu items backward of the Nth menu item, the second movement step moves the cursor from the Nth menu item directly back to the first menu item so as to designate the menu item displayed the predetermined number nj of menu items ahead of the menu item being designated by the cursor. In the embodiment thus arranged, when the first and/or second operator is activated while the cursor is designating the Nth menu item or other menu item neighboring the N menu item, the cursor is moved, in response to activation of the first or second operator, directly back to the first menu item in a cyclic fashion. Such cursor movement can even further facilitate the menu item selecting operation.

In another embodiment of the second-aspect menu item selection method, the predetermined direction is a direction from the Nth menu item toward the first menu item. When the first operator is activated while the cursor is designating the first menu item, the first movement step moves the cursor to designate the Nth menu item. When the second operator is activated while the cursor is designating any one of the menu items within a range from the first menu item to the menu item displayed the predetermined number k (k=nj−1) of menu items backward of the first menu item, the second movement step moves the cursor from the first menu item directly back to the Nth menu item so as to designate the menu item displayed the predetermined number nj of menu items ahead of the menu item being designated by the cursor. In the embodiment thus arranged, when the first and/or second operator is activated while the cursor is designating the first menu item or other menu item neighboring the first menu item, the cursor is moved, in response to activation of the first or second operator, directly back to the Nth menu item in a cyclic fashion. Such cursor movement can even further facilitate the menu item selecting operation.

According to still another aspect of the present invention, there is provided a small-sized information terminal apparatus which comprises: a display section; a display unit for displaying first to Nth (N≧3) menu items on the display section in order of menu item numbers, as well as a cursor for designating any one of the menu items; first to fourth operators for controlling movement, on the display section, of the cursor; a first movement section for, each time the first operator is activated, moving the cursor, in a first direction from the first menu item toward the Nth menu item, to designate the menu item next to the menu item currently designated by the cursor; a second movement section for, each time the second operator is activated, moving the cursor, in the first direction, to designate the menu item displayed a predetermined number nj (nj≧2) of menu items ahead of the menu item currently designated by the cursor; a third movement section for, each time the third operator is activated, moving the cursor, in a second direction from the Nth menu item toward the first menu item, to designate the menu item next to the menu item currently designated by the cursor; a fourth movement section for, each time the fourth operator is activated, moving the cursor, in the second direction, to designate the menu item displayed the predetermined number nj of menu items ahead of the menu item currently designated by the cursor; a selection operator for selecting a desired one of the first to Nth menu items; a detection section for detecting whether the selection operator has been activated while any one of the first to Nth menu items is being designated by the cursor; and a selection section for selecting the menu item being designated by the cursor, in response to detection, by the detection section, activation of the selection operator.

The small-sized information terminal apparatus of the present invention includes: the first movement section for moving the cursor to the next menu item in the first direction in response to each activation of the first operator; the second movement section for moving the cursor in the first direction to the menu item displayed the predetermined number nj of menu items ahead of the menu item currently designated by the cursor in response to each activation of the second operator; the third movement section for moving the cursor to the next menu item in the second direction, opposite from the first direction, in response to each activation of the third operator; and the fourth movement section for moving the cursor in the second direction to the menu item displayed the predetermined number nj of menu items ahead of the menu item currently designated by the cursor in response to activation of the fourth operator. Thus, to select a given menu item remote from the menu item currently designated by the cursor, the cursor may be jumped using the second or fourth operator, with the result that the present invention can reduce the necessary number of operations of the operators and thus allows the user to select a desired menu item with simpler operation.

In an embodiment of the small-sized information terminal apparatus, when the first operator is activated while the cursor is designating the Nth menu item, the first movement section moves the cursor to designate the first menu item. When the second operator is activated while the cursor is designating any one of the menu items within a range from the Nth menu item to the menu item displayed the predetermined number k (k=nj−1) of menu items backward of the Nth menu item, the second movement section moves the cursor from the Nth menu item directly back to the first menu item so as to designate the menu item displayed the predetermined number nj of menu items ahead of the menu item being designated by the cursor. When the third operator is activated while the cursor is designating the first menu item, the third movement section moves the cursor to designate the Nth menu item. When the fourth operator is activated while the cursor is designating any one of the menu items within a range from the first menu item to the menu item displayed the predetermined number k (k=nj−1) of menu items backward of the first menu item, the fourth movement section moves the cursor from the first menu item directly back to the Nth menu item so as to designate the menu item displayed the predetermined number nj of menu items ahead of the menu item being designated by the cursor. In the embodiment thus arranged, when the first and/or second operator is activated while the cursor is designating the Nth menu item or other menu item neighboring the N menu item, the cursor is moved, in response to activation of the first or second operator, directly back to the first menu item in a cyclic fashion. Such cursor movement can even further facilitate the menu item selecting operation. Further, when the third and/or fourth operator is activated while the cursor is designating the first menu item or other menu item neighboring the first menu item, the cursor is moved, in response to activation of the third or fourth operator, directly back to the Nth menu item in a cyclic fashion. Such cursor movement can even further facilitate the menu item selecting operation.

Further, in the small-sized information terminal apparatus, the first and third operators are provided for controlling vertical movement of the cursor in an operation mode different from a menu item selection mode where one of the first to Nth menu items being designated by the cursor is selected in response to activation of the selection operator, and the second and fourth operators are provided for controlling horizontal movement of the cursor in the operation mode different from the menu item selection mode. The functions of these first to fourth operators may be assigned to existing cursor-moving operators, in which case it is possible to avoid an increase in the number of the operators on the terminal apparatus.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing a general setup of a cellular phone to which is applied an embodiment of the present invention;

FIG. 2 is a front view showing an outer appearance of the cellular phone of FIG. 1;

FIGS. 3A to 3C are diagrams explanatory of a first embodiment of a menu item selection method of the present invention;

FIGS. 4A and 4B are diagrams explanatory of an example of operation for selecting a menu item on the basis of a screen display;

FIGS. 5A to 5E are diagrams explanatory of an example of operation for selecting a menu item on the basis of guide sounds;

FIG. 6 is a flow chart showing an exemplary step sequence of a menu item selection process based on the first embodiment of the menu item selection method of the invention;

FIG. 7 is a front view showing an outer appearance of another type of cellular phone to which is applied another embodiment of the present invention;

FIG. 8 is a diagram explanatory of cursor movement according to the second embodiment of the menu item selection method of the invention in a case where numbers of forward and backward jumped items are both set to “2”;

FIG. 9 is a diagram explanatory of a first example of operation for selecting ITEM 6 in accordance with the second embodiment of the menu item selection method;

FIG. 10 is a diagram explanatory of a second example of operation for selecting ITEM 6 in accordance with the second embodiment of the menu item selection method;

FIG. 11 is a diagram showing a comparison between the menu item selection method of the present invention and the conventional menu item selection method in terms of a minimum number of button operations necessary for selection of each individual item in two menus having eight and eleven selectable items, respectively;

FIG. 12 is a flow chart showing an exemplary step sequence of a menu item selection process based on the second embodiment of the menu item selection method of the invention;

FIG. 13 is a diagram showing an example of a conventionally-known menu item selection method;

FIG. 14 is a diagram showing another example of the conventionally-known menu item selection method;

FIG. 15 is a diagram showing an example of a conventional hierarchical organization of menus for use in a cellular phone or the like;

FIG. 16 is a diagram showing still another example of the conventionally-known menu item selection method;

FIG. 17 is a diagram showing still another example of the conventionally-known menu item selection method; and

FIG. 18 is a diagram showing still another example of the conventionally-known menu item selection method.

### DETAILED DESCRIPTION OF THE PREFERRED EMBODIMENTS

The following will describe embodiments of the present invention, but it should be appreciated that the present invention is not limited to the described embodiments and various modifications of the invention are possible without departing from the basic principles. The scope of the present invention is therefore to be determined solely by the appended claims.

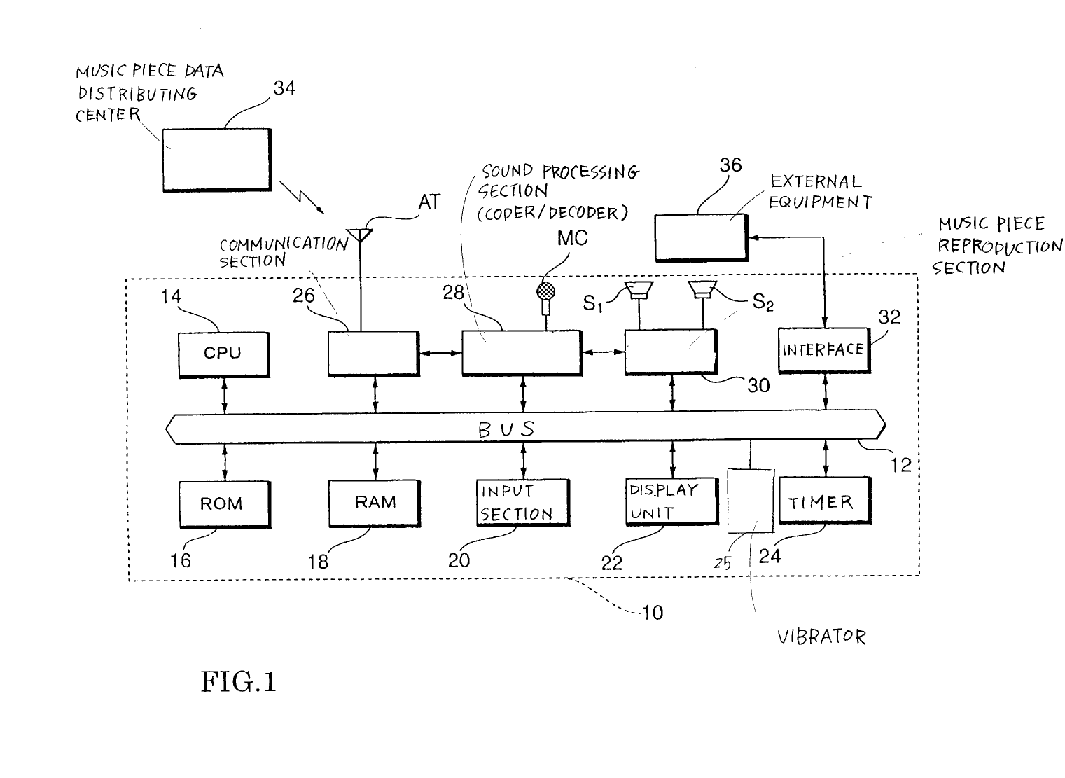

FIG. 1 is a block diagram showing a general setup of a cellular phone to which is applied an embodiment of the present invention. The cellular phone 10 has a bus 12, to which are connected a CPU (Central Processing Unit) 14, ROM (Read-Only Memory) 16, RAM (Random Access Memory) 18, input section 20, display unit 22, timer 24, vibrator 25, communication section 26, sound processing section 28, tone reproduction section 30, interface 32, etc.

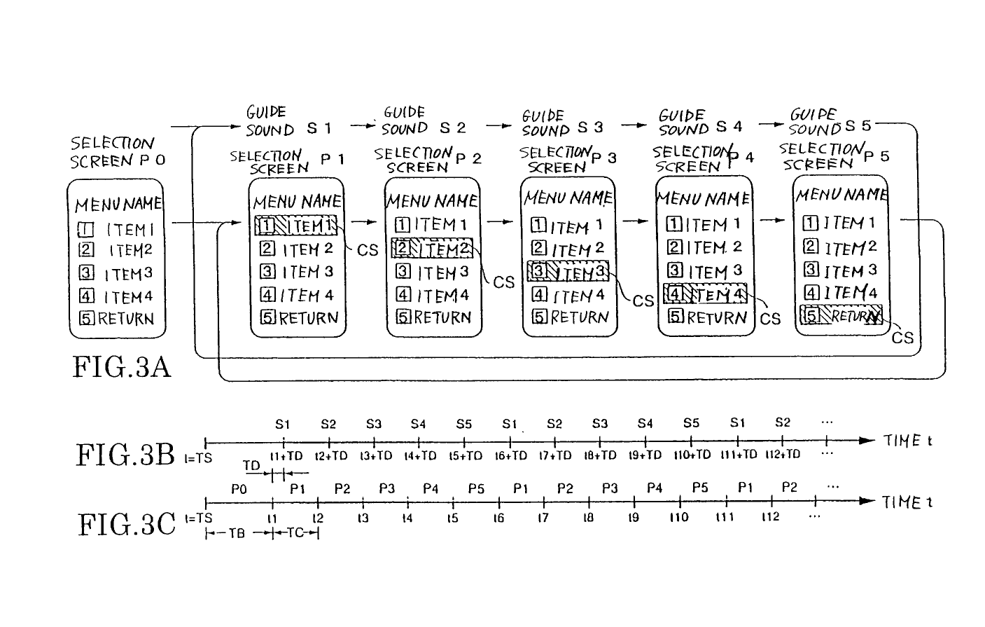

The CPU 14 carries out a transmission process, reception process, menu item selection processing, etc. in accordance with various programs stored in the ROM 16. The menu item selection processing will be later described in detail with reference to FIGS. 3 to 6 and 8 to 12. In the ROM 16, there are prestored, in addition to the programs, music piece data for generating incoming-call alerting tones, hold tones, BGM tones and the like, and sound data for generating guide sounds, such as pips, to be described later.

The RAM 18 includes storage areas to be used as registers, flags, etc. in various processes performed by the CPU 14. The RAM 18 can also store music piece data for generating incoming-call alerting tones which are loaded from a music-piece-data distributing center 34 via an antenna AT and communication section 26.

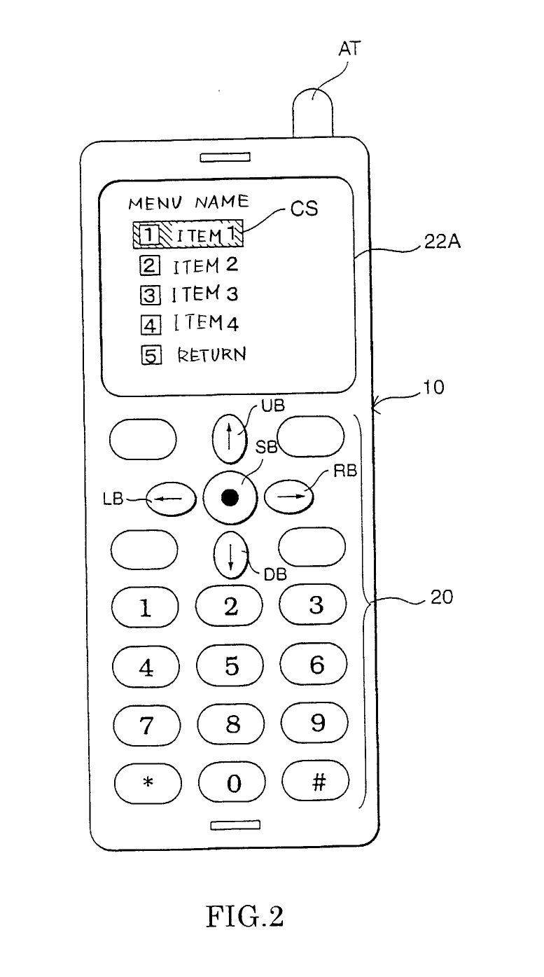

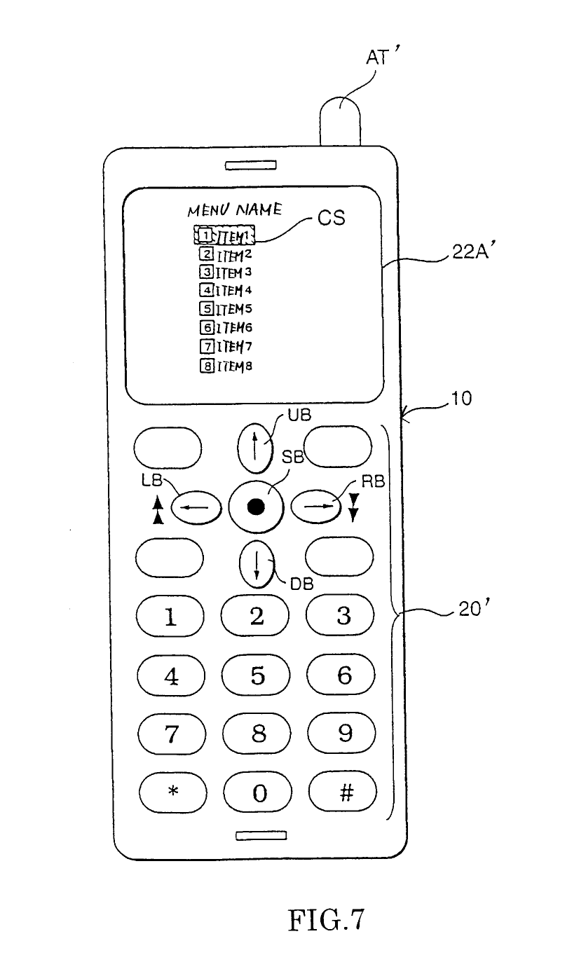

The input section 20 includes various input buttons (keys) provided on the body of the cellular phone 10 as shown in FIG. 2 or 7. Among the various input buttons are numeric buttons “0” to “9”, cursor-moving buttons such as up arrow button UB, down arrow button DB, left arrow button LB and right arrow button RB, and selection button SB.

The display unit 22 includes a display section 22A (or 22A′) provided on the body of the cellular phone 10 as shown in FIG. 2 (or FIG. 7), and various pieces of information are displayed on the display section 22A (or 22A′). In the later-described menu item selection processing, there are displayed, on the display section 22A (or 22A′), a plurality of menu items along with a cursor CS capable of sequentially designating the menu items in a cyclic fashion. The timer 24 generates time information representative of a time value changing in accordance with progression of time. The vibrator 25 vibrates the body of the cellular phone 10, to inform a user of arrival of an incoming cal, in place of incoming call alerting tones.

The communication section 26 demodulates each signal received via the antenna AT, and also modulates each signal to be transmitted so as to transmit the modulated signal. The antenna AT is provided on the body of the cellular phone 10 for telescopic movement between a contracted position of FIG. 2 or 7 and an expanded position (not shown).

The sound processing section 28 includes a coder/decoder for efficiently compressing and coding or decoding a voice signal. Namely, each voice signal to be transmitted having been picked up by the microphone MC is compressed and coded by the sound processing section 28 and then supplied to the communication section 26. Each received signal demodulated via the communication section 26 is decoded by the sound processing section 28 and supplied to the music piece reproduction section 30, where it is audibly reproduced via a first speaker S₁.

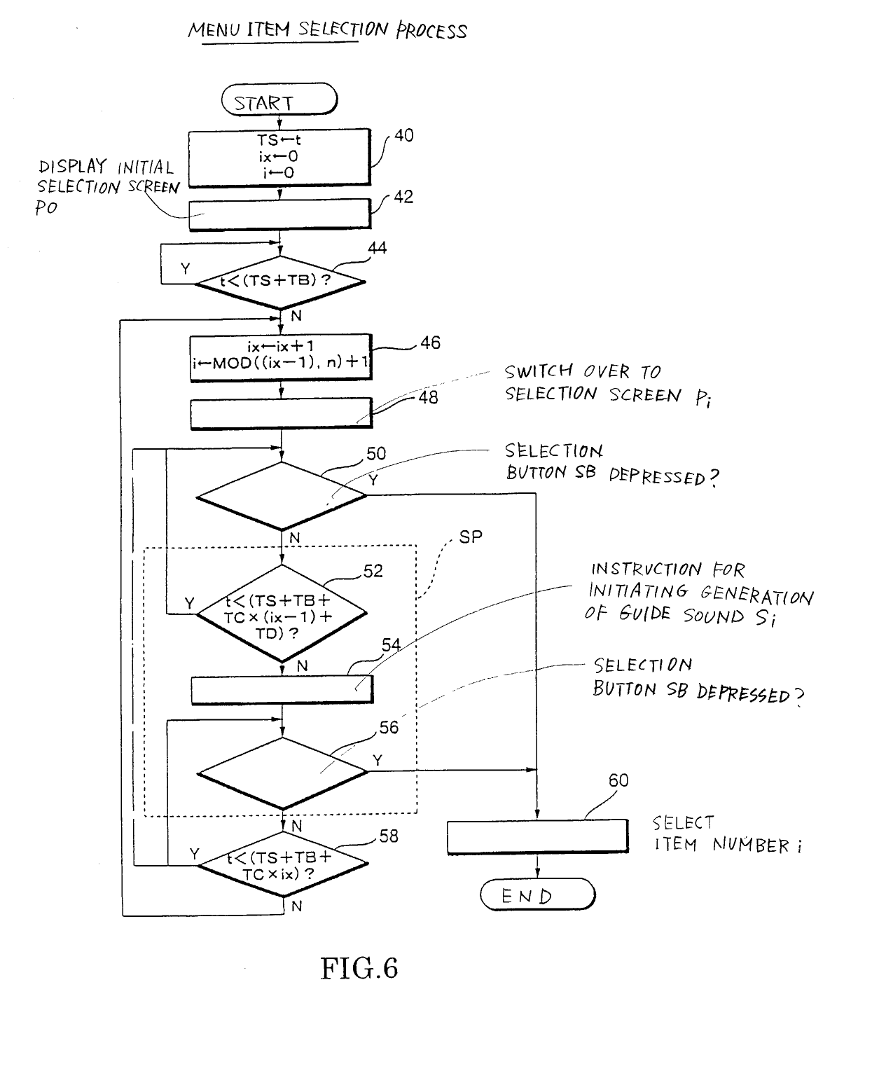

Specifically, the music piece reproduction section 30 generates incoming-call alerting tone signals on the basis of corresponding music piece data stored in the ROM 16 or RAM 18 for the incoming-call alerting tone generation purposes. The incoming-call alerting tone signals are audibly reproduced or sounded by a second speaker S₂. The music piece reproduction section 30 also generates hold tone signals and BGM tone signals on the basis of corresponding music piece data stored in the ROM 16, and these hold tone signals and BGM tone signals can be audibly reproduced or sounded through the first speaker S₁. In the later-described menu item selection process of FIG. 6, the music piece reproduction section 30 also generates a guide sound signal on the basis of tone data stored in the ROM 16, and the thus-generated guide sound signal is sounded through either or both of the speakers S₁ and S₂.

The interface 32 is provided for data exchange or communication between the cellular phone 10 and external equipment 36 such as a personal computer. In the case where the external equipment 36 connected with the cellular phone 10 is a personal computer, desired music piece data can be downloaded from the personal computer to the RAM 18 of the cellular phone 10. Incoming-call alerting tone signals can also be generated on the basis of such downloaded music piece data.

Now, with reference to FIG. 3, a description will be made about a first embodiment of the menu item selection method of the present invention, which is suitable for use in the cellular phone 10 that is constructed to display a menu showing five selectable items or options, ITEM 1 to ITEM 4 and ITEM 5, “RETURN”. When the given menu item selection process is started up in response to operation in a menu of a predetermined higher hierarchical level, selection screen P0 shows up on the display section 22A as shown in FIGS. 3A and 3C. Only five menu items, ITEM 1 to ITEM 4 and ITEM 5, “RETURN”, are shown on this selection screen P0 with no cursor shown on the screen. Selection screen P0 is displayed for a predetermined time period TB that is considered necessary for the user to appreciate or grasp the displayed contents of the menu. Let's assume that the cellular phone 10 is arranged to not allow the user to select any menu item during display of selection screen P0. Namely, if a time point to start displaying selection screen P0 (menu display start timing) is represented by TS as illustrated in FIG. 3C, selection screen P0 is displayed for the time period TB starting at the time point TS. The time period TB is an initial display time period whose value can be designated as desired by the user. Note that reference character “t” in FIGS. 3 to 6 represents a time.

Upon arrival at a time point t1, i.e. once the initial display time period TB has elapsed from the time point TS, selection screen P1 is automatically displayed to replace selection screen P0 as shown in FIGS. 3A and 3C. On this selection screen P1, there are shown ITEM 1 to ITEM 5 and a cursor CS designating ITEM 1.

Upon arrival at a next time point t2, i.e. once a predetermined time TC has elapsed from the time point t1, selection screen P2 is automatically displayed to replace selection screen P1 as shown in FIGS. 3A and 3C. On this selection screen P2, there are shown ITEM 1 to ITEM 5 and the cursor CS designating ITEM 2. Here, the predetermined time TC defines a display switching time, which can be designated as desired by the user.

Upon arrival at a further next time point t3, i.e. once the predetermined time TC has elapsed from the time point t2, the displayed screen is automatically switched over to P3 as shown in FIGS. 3A and 3C. On this selection screen P3, there are shown ITEM 1 to ITEM 5 and the cursor CS designating ITEM 3. After that, selection screen P4 with the cursor CS designating ITEM 4 and selection screen P5 with the cursor CS designating ITEM 5 are automatically displayed sequentially in a similar manner to the above-mentioned selection screens, as shown in FIGS. 3A and 3C. Whereas five menu items are shown in FIG. 3 as displayed on the display section 22A, the number “n” of the menu items may be set to be greater or smaller than five.

Then, upon arrival at a still next time point t6, i.e. once the predetermined time TC has elapsed from the time point t5, selection screen P1 with the cursor CS designating ITEM 1 is again automatically displayed to replace selection screen P5 as shown in FIGS. 3A and 3C. Upon arrival at a still next time point t7, i.e. once the predetermined time TC has elapsed from the time point t6, selection screen P2 with the cursor CS designating ITEM 2 is automatically displayed to replace selection screen P1 as shown in FIGS. 3A and 3C. After that, selection screens P3, P4 and P5 are automatically displayed sequentially at predetermined time intervals, defined by the time TC, in a similar manner to the foregoing, and then selection screen P5 is again replaced by selection screen P1. In this manner, selection screen P1 to selection screen P5 are automatically displayed cyclically while being switched at the predetermined time intervals TC. In other words, such a switched display of the selection screens can be said to be a display of the cursor CS automatically moving to sequentially designate ITEM 1 to ITEM 5 in a cyclic fashion.

The above-mentioned time points t1, t2, t3, t4, . . . can be expressed as follows, using the menu-display starting time TS, initial display time period TB and display switching time TC:

t1=TS+TB+TC×0

t2=TS+TB+TC×1

t3=TS+TB+TC×2

t4=TS+TB+TC×3

The user can select a desired one of the menu items by visually following changes in the displayed selection screen (namely, changing movement of the cursor) and depressing the selection button SB while the cursor is designating the desired menu item.

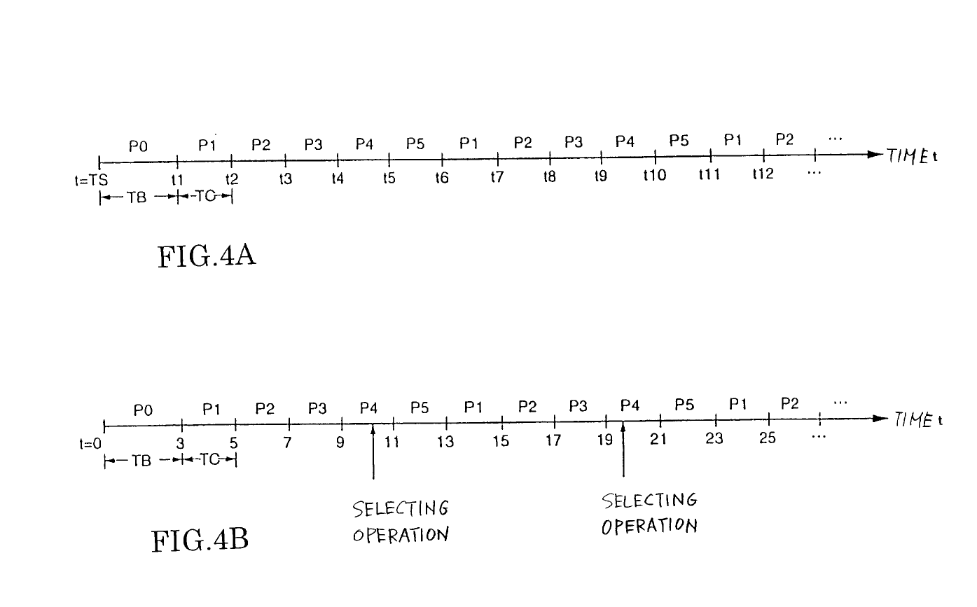

FIGS. 4A and 4B are explanatory of an example of operation for selecting a menu item on the basis of the screen display, of which FIG. 4A illustrates display timing of selection screen PO to selection screen P5 similarly to FIG. 3C. FIG. 4B illustrates display timing of selection screen P0 to selection screen P5 in relation to values of the time points t1, t2, t3, t4, . . . determined as follows assuming n=5, TS=0, TB=3 and TC=2.

t1=TS+TB+TC×0=0+3+2×0=3

t2=TS+TB+TC×1=0+3+2×1=5

t3=TS+TB+TC×2=0+3+2×2=7

t4=TS+TB+TC×3=0+3+2×3=9

For example, when ITEM 4 is to be selected, the user depresses the selection button SB within a time period after the automatically moving cursor CS has shifted from ITEM 3 to ITEM 4 but before the cursor CS shifts from ITEM 4 to ITEM 5 (e.g., within any one of time periods represented by 9≦t<11, 19≦t<21, . . . ). In this way, the user can select the desired menu item by only one depression (one click) of the one button, i.e. one depression of the selection button SB; besides, in the present invention, it is not necessary for the user to move his or her thumb a great distance, by contrast to the conventional menu item selection method where one of a plurality of numeric buttons has to be manipulated for the menu item selection. As a result, the cellular phone 10 allows the user to select a desired menu item with much simpler operation and with utmost ease.

According to the above-described first embodiment of the menu item selection method, there may be generated guide sounds S1, S2, S3, S4, . . . , at timing t1+TD, t2+TD, t3+TD, t4+TD, . . . , for providing the user with an audible operating guide to appropriately select a desired menu item. Here, “TD” represents a predetermined time of a guide sound generation delay relative to the display switching time (t1 or the like), and the user can designate a desired value of the guide sound generation delay time TD within the limits of 0<TD<TC. The reason why the timing to generate the guide sound is delayed (by the guide sound generation delay time TD) behind the cursor display start timing for each of the menu items is to appropriately deal with a likely situation where the user depresses the selection button SB slightly earlier than the predetermined guide sound generation timing.

Upon arrival at the time point t1+TD, generation of a guide sound S1 is initiated as illustrated in FIGS. 3A and 3B. The generation of the guide sound S1 is caused to last for a predetermined time period shorter than the display switching time TC. Similarly, a guide sound S2 is generated upon arrival at the time point t2+TD, guide sound S3 generated upon arrival at the time point t3+TD, guide sound S4 generated upon arrival at the time point t4+TD, and guide sound S5 generated upon arrival at the time point t5+TD.

Then, upon arrival at the time point t6+TD, the guide sound S1 is again generated as illustrated in FIGS. 3A and 3B. After that, the guide sounds S2, S3, S4 and S5 are sequentially generated at the predetermined time intervals TC, and then the guide sound S1 is again generated following the guide sound S5; namely, the guide sounds S1, S2, S3, S4 and S5 are generated cyclically in the mentioned order. In other words, the guide sounds S1, S2, S3, S4, S5, S1, . . . are generated in synchronism with selection screens P1, P2, P3, P4, P5, P1, . . . , as seen in FIG. 3. In this way, the user can accurately select a desired menu item by counting the sequentially generated guide sounds like voice “one”, “two”, “three”, “four”, . . . and depressing the selection button SB when a predetermined number of the guide sounds corresponding to the desired menu item have been generated.

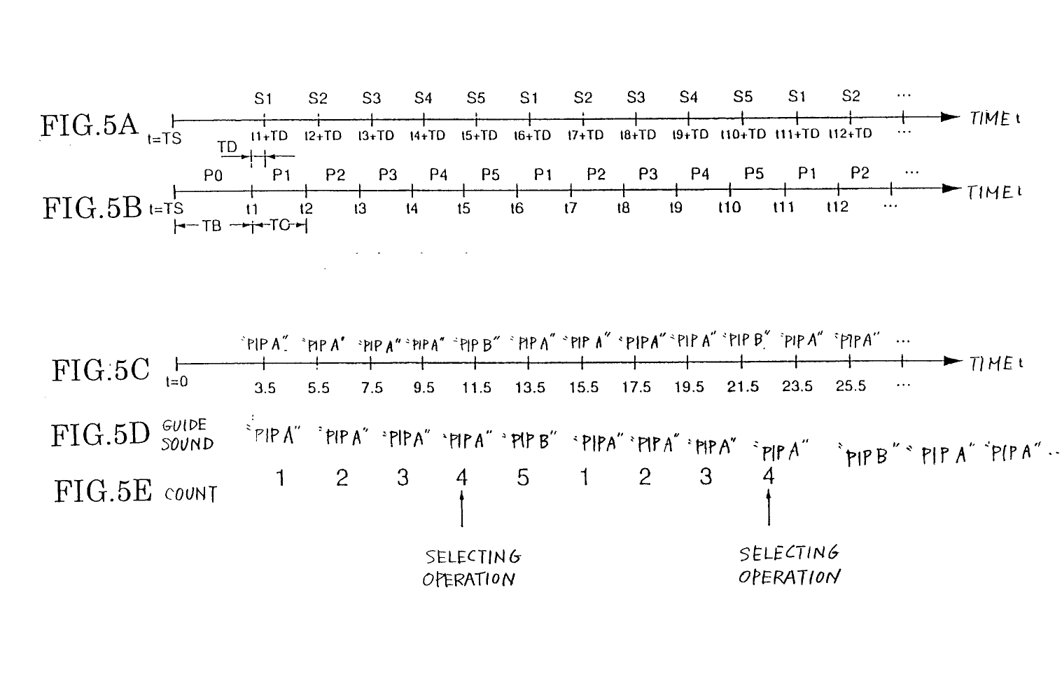

FIGS. 5A to 5E are explanatory of another example of operation for selecting a menu item on the basis of the guide sounds, of which FIGS. 5A and 5B illustrate display timing of selection screen P0 to selection screen P5 and generation timing of the guide sounds S1 to S5 similarly to FIGS. 3B and 3C.

Specifically, FIG. 5C illustrates exemplary generation timing of the guide sounds S1, S2, S3, S4, . . . in relation to values, t1+TD=3.5, t2+TD=5.5, t3+TD=7.5, t4+TD=9.5, assuming that TS=0, TB=3 and TC=2 and TD=0.5 and the values of the time points t1, t2, t3, t4, . . . are “3”, “5”, “7”, “9”, . . . , respectively, as in the case of FIG. 4B and that each of the guide sounds S1 to S4 is electronic pip A having a first frequency pitch for example “Pip” while the guide sound S5 is electronic pip B having a second pitch for example “Pop”. In this case, the guide sounds are generated in a manner as shown in FIG. 5D, and the user can count the number of the generated guide sounds as illustrated in FIG. 5E.

For example, for selection of ITEM 4, the user counts the number of the automatically generated guide sounds and depresses the selection button SB once the fourth guide sound pip A has been generated. The selection of ITEM 4 can be made within a time period from the predetermined time TD earlier than the generation start timing of the fourth guide sound S4 to the predetermined time TD earlier than the generation start timing of the fifth guide sound S5 (i.e., within a time period represented by 9≦t<11). Particularly, because the generation start timing of the guide sound S4 is delayed by the time TD behind the display start timing of corresponding selection screen P4 in the instant example, ITEM 4 can be selected appropriately even when the selection button SB is prematurely depressed within the time TD immediately before the generation start timing (t4+TD) of the guide sound S4. After a lapse of the time period represented by 9<t<11, ITEM 4 can also be selected within another time period represented by, for example, 19≦t<21.

According to the example of the operation for selecting a menu item on the basis of the guide sounds having been described with reference to FIGS. 5A to 5E as well, the user can select any desired menu item by only one depression or activation of the one button, i.e. one depression or activation of the selection button SB. Thus, this example of the selecting operation can achieve advantageous results similar to those attained by the screen-display-based selecting operation described above with reference to FIGS. 4A and 4B. Further, if the user knows correspondency among the menu items, the number and types of generated guide sounds, etc., the user can make an accurate menu item selection without having to staring at tiny letters on the selection screen, and thus necessary menu item operation can be simplified or facilitated even further. Particularly, as the user gets more accustomed to the menu item selecting operation, the user may be able to select a desired menu item only on the basis of the generated guide sounds; in extreme cases, even a visually impaired person may be allowed to perform appropriate menu item selecting operation.

Whereas the guide sounds have been described as simple pips of difference frequencies or pitches, such as “PIP A” and “PIP B”, voices (words) easier to identify, like “one”, “two”, “three”, . . . may be generated as the guide sounds. The initial display time period TB, time interval TC and guide sound generation delay time TD may be set to appropriate time values depending on skill, capability and/or the like of the user. For example, for aged and physically/mentally handicapped persons, longer time values may be set to permit slower menu item selecting operation, while for persons of higher skill, shorter time values may be set to permit quicker and rhythmical menu item selecting operation.

FIG. 6 is a flow chart showing an exemplary step sequence of the menu item selection process based on the first embodiment of the menu item selection method. At step 40, a time value t indicated by time information generated by the timer 24 of FIG. 1 (hereinafter also referred to as a “timer time”) is set as the menu display start time TS, and a value “0” is set as both a frame number ix and an item number i.

At next step 42, initial selection screen P0 is displayed on the display section 22A in the manner as shown in FIG. 3A. Then, at step 44, a determination is made as to whether the current timer time t is smaller than a sum of the values of the menu display start time TS and initial display time period TB (t<(TS+TB)). With an affirmative or YES (“Y”) determination, the operation of step 44 is repeated until the current timer time t becomes equal to or greater than the sum (t>(TS+TB)), i.e. until the current timer time t reaches the time point t1 shown in FIG. 3C. This operation corresponds to the operation for displaying selection screen P0 for the initial display time period TB starting at the time point TS as shown in FIGS. 3A and 3C.

Once the current timer time t becomes equal to or greater than the sum (i.e., once the condition “t≧(TS+TB)” is satisfied), a negative or NO (“N”) determination is made at step 44. Thus, at step 46, the frame number ix is incremented by one, and a calculation result of “MOD ((ix−1), n)+1” is set as the item number i. Here, MOD ((ix−1), n) represents a remainder obtained when the integer “(ix−1)” is divided by the integer “n” (integral calculation). “n” represents the number of the selectable menu items, which is “5” (n=5) in this case. When step 46 is taken for the first time after step 40, the frame number ix is “1” (ix=1), so that “MOD ((ix−1), n)” (in this case, MOD ((1−1), 5)) becomes “0” and thus a value “1” is set as the item number i.

At following step 48, the displayed screen is switched over to next selection screen Pi. When step 48 is taken for the first time after step 42, Pi equals P1 (Pi=P1), so that selection screen P1 is displayed on the screen section 22A to replace selection screen P0. This operation corresponding to the operation for displaying selection screen P1 at the time point t1 in FIGS. 3A and 3C.

At step 50, it is determined whether the selection button SB has been depressed by the user. With a negative (N) determination, the process goes to step 52, where a further determination is made as to whether the current timer time t is smaller in value than a sum among 1) the values of the menu display start time TS and 2) the initial display time period TB, 3) a product of the display switching time TC and (ix−1) and 4) the value of the guide sound generation delay time TD ((t<(TS+TB+TC×(ix−1)+TD)). With an affirmative or YES (“Y”) determination, the operation of step 52 is repeated until the current timer time t becomes equal to or greater than the sum, i.e. until the condition of “t>(TS+TB+TC×(ix−1)+TD)” is satisfied. When step 52 is taken for the first time after step 40, the item number ix is “1”, so that the operation of step 52 is repeated until the condition of “t>(TS+TB+TC)” is met (until the time point tl+TD of FIG. 3B is reached).

Once the condition of “t>(TS+TB+TC×(ix−1)+TD)” is met, a negative (N) determination is made at step 52, and then the music piece reproduction section 30 is instructed at step 54 to initiate generation of a guide sound Si. In response to such an instruction for initiating the generation of the guide sound Si, the music piece reproduction section 30 reads out, from the ROM 16, sound data corresponding to the guide sound Si, generates a guide sound signal corresponding to the guide sound Si, and supplies the thus-generated guide sound signal to either or both of the first and second speakers S₁ and S₂. As a consequence, the guide sound Si is audibly generated for a predetermined time period shorter than the display switching time TC. When step 54 is taken for the first time after step 40 by way of step 52, the guide sound S1 is generated at the time t1+TD as illustrated in FIG. 3B.

At step 56, it is determined whether the selection button SB has been depressed by the user. With a negative (N) determination, the selection process goes to step 58, where a further determination is made as to whether the current timer time t is smaller than a sum among the values of the menu display start time TS and initial display time period TB and a product of the display switching time TC and ix ((t<(TS+TB+TC×ix)). With an affirmative or YES (“Y”) determination, the operations of steps 50 to 58 are repeated until the current timer time t becomes equal to or greater than the sum, i.e. until the condition of “t>(TS+TB+TC×ix)” is satisfied. When step 58 is taken for the first time after step 40, ix=1, so that the operations of steps 50 to 58 are repeated until the condition of “t≧(TS+TB+TC)” is met (until the time point t2 of FIG. 3C is reached).

Once the condition of “t>(TS+TB+TC×ix)” is met, a negative (N) determination is made at step 58, so that the selection process reverts to step 46 in order to repeat the above-described operations at and after step 46. In this way, selection screens P2, P3, P4, P5, P1, . . . are sequentially displayed in a cyclic fashion, and the corresponding guide sounds S2, S3, S4, S5, S1, . . . are audibly generated in synchronism with the display of such selection screens P2, P3, P4, P5, P1, . . . .

Thus, the user depresses the selection button SB at given timing corresponding to a desired one of the menu items, on the basis of the display of the selection screens and/or the generation of the guide sounds. The depression or activation of the selection button SB is detected at step 50 when (TS+TB+TC×(ix−1))≧t<(TS+TB+TC×(ix−1)+TD), e.g. when t1≧t<(TS+TB++TD)=(t1+TD), or at step 56 when (TS+TB+TC×(ix−1)+TD)≧t<(TS+TB+TC×ix), e.g. when (t1+TD)≧t<(TS+TB++TD)=t2. Namely, once an affirmative (Y) determination is made at step 50 or 56, the menu item represented by the item number i is selected at step 60. For example, if the selection button SB is depressed at timing corresponding to selection screen P4 and/or guide sound S4, ITEM 4 can be selected at step 60.

When no guide sound is to be generated in the menu item selection process of FIG. 6, it just suffices to dispense with the guide sound generating operations SP at steps S52 to 56. In this case, when an affirmative determination is made at step 58, the menu item selection process reverts to step 50 to repeat the operations of steps 50 and 58 until the condition “t≧(TS+TB+TC×ix)” is met.

It should be appreciated that the menu item selection method of the present invention having described above may be applied to other small-sized information terminal apparatus than cellular phones, such as game apparatus.

In summary, the first embodiment of the present invention having been described above with reference to FIGS. 1 to 6 is characterized primarily in that the plurality of menu items are displayed along with the cursor CS in such a manner that the cursor sequentially designates the individual menu items in a cyclic fashion and any one of the menu items being designated the cursor can be selected by activation of the selection button SB. With such arrangements, the first embodiment of the present invention allows the user to readily select a menu item by only operating or activating the selection button SB.

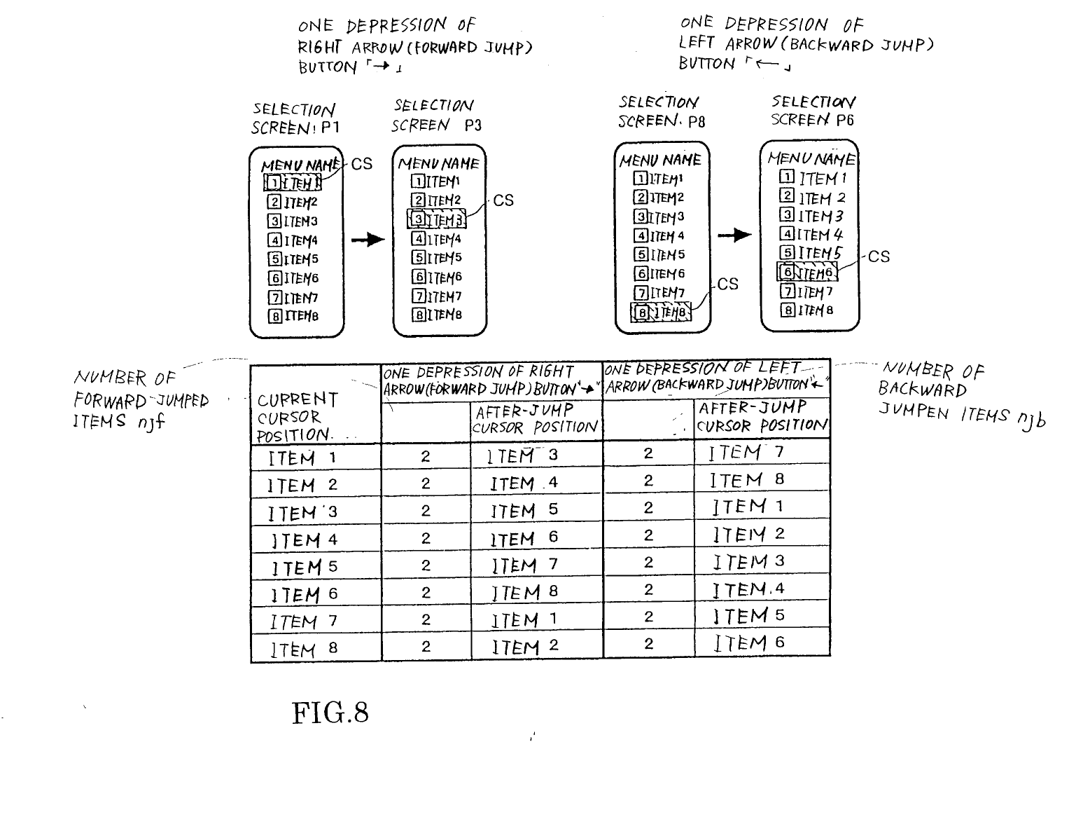

Now, a description will be made about a second embodiment of the menu item selection method of the present invention with reference to FIGS. 8 to 12, which is suitable for use in a cellular phone 10 as shown in FIG. 7 that is arranged to display a menu showing eight selectable items or options, ITEM 1 to ITEM 8. Note that the cellular phone 10 shown in FIG. 7 has a general construction as described above in relation to FIG. 1; namely, the cellular phones 10 shown in FIG. 7 is similar in general construction to the one shown in FIG. 2.

The cellular phone 10 of FIG. 7 includes, as cursor moving operators, the down arrow button DB, up arrow button UB, right arrow button RB and left arrow button LB. Each of the down arrow button DB and up arrow button UB is operable to move the cursor CS downwardly or upwardly, one item at a time (per depression of the button). Namely, depressing the down arrow button DB once causes the cursor CS to move to the item immediately below the item currently designated by the cursor CS; however, if the down arrow button DB is depressed while the cursor CS is designating ITEM 8 at the bottom of the displayed menu, the cursor CS is caused to jump upwardly to designate ITEM 1 at the top of the displayed menu. Similarly, depressing the up arrow button UB once causes the cursor CS to move to the item immediately above the item currently designated by the cursor CS; however, if the up arrow button UB is depressed while the cursor CS is designating ITEM 1 at the top of the displayed menu, the cursor CS is caused to jump downwardly to designate ITEM 8 at the bottom of the displayed menu.

In the cellular phone 10 of FIG. 7, the right arrow button RB and left arrow button LB are used as a forward jump button and backward jump button, respectively, such that each of the buttons RB and LB is operable for causing the cursor CS to jump downwardly or upwardly to a given menu item that is displayed a predetermined number nj (nj≧2) of menu items ahead of the menu item currently designated by the cursor CS. Here, the predetermined number nj is also referred to as a “number of jumped items”; particularly, the number of jumped items pertaining to the forward jump button is called a “number of forward jumped items” njf while the number of jumped items pertaining to the backward jump button is called a “number of backward jumped items” njb. These numbers of jumped items njf and njb are each designatable as desired by the user from among integral or whole numbers greater than one (2, 3, . . . ).

FIG. 8 is a diagram showing an exemplary manner in which the cursor moves in response to activation of the right arrow (forward jump) button RB or left arrow (backward jump) button LB when the numbers of jumped items njf and njb are both set to “2” (njf=njb=2). If the right arrow button RB is depressed once, the cursor CS moves downward to designate the second menu item from the menu item currently designated by the cursor CS, i.e. the menu item displayed the predetermined number nj of menu items ahead of the currently designated menu item. However, if the right arrow (forward jump) button RB is depressed once while the cursor CS is designating the lowest or lowest-but-one menu item, the cursor CS jumps back upward to the top of the menu so as to designate the second menu item from the currently-designated menu item, i.e. the menu item displayed the predetermined number nj of menu items ahead of the currently designated menu item; namely, in the illustrated example, if the right arrow button RB is depressed once while the cursor CS is designating ITEM 7 or ITEM 8, the cursor CS jumps to designate ITEM 1 or ITEM 2.

If the left arrow (backward jump) button LB is depressed once, the cursor CS moves upward to designate the second menu item from the menu item currently designated by the cursor CS. However, if the left arrow button LB is depressed once while the cursor CS is designating the highest or highest-but-one menu item, the cursor CS jumps back downward to the top of the menu so as to designate the second menu item from the currently-designated menu item; namely, in the illustrated example, if the left arrow button LB is depressed once while the cursor CS is designating ITEM 1 or ITEM 2, the cursor CS jumps to designate ITEM 7 or ITEM 8.

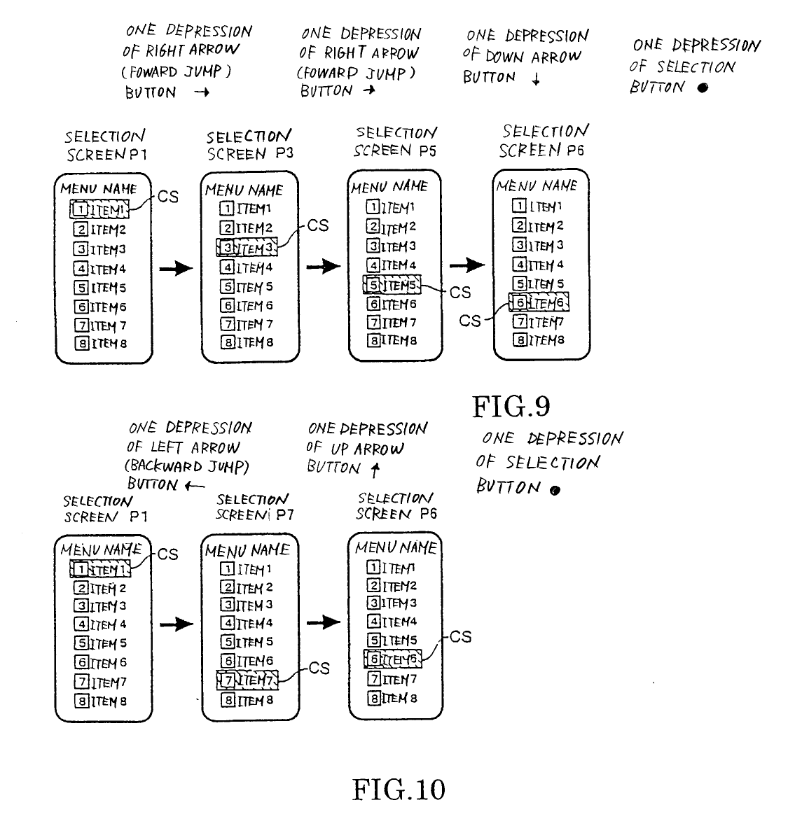

FIG. 9 is explanatory of a first example of operation for selecting a desired menu item (in this case, ITEM 6) in accordance with the second embodiment of the menu item selection method. When a given menu item selection process is started up in response to operation in a menu of a predetermined higher hierarchical level, selection screen P1 shows up on the display section 22A′ as shown in FIG. 9. On selection screen P1, there are shown ITEM 1 to ITEM 8 with the cursor CS designating ITEM 1.

If the right arrow (forward jump) button RB is depressed once while selection screen P1 is being displayed, the displayed screen is switched from selection screen P1 over to selection screen P3 with the cursor CS designating ITEM 3. Then, if the right arrow button RB is depressed once while selection screen P3 is being displayed, the displayed screen is switched over to selection screen P5 with the cursor CS designating ITEM 5. Then, by depressing the down arrow button DB once while selection screen P5 is being displayed, the displayed screen is switched over to selection screen P6 with the cursor CS designating ITEM 6, and in this state, ITEM 6 can be selected by depressing the selection button SB once.

FIG. 10 is explanatory of a second example of operation for selecting a desired menu item (in this case, ITEM 6) in accordance with the second embodiment of the menu item selection method. Here, if the left arrow (backward jump) button LB is depressed once while selection screen P1 is being displayed, the displayed screen is switched over to selection screen P7 with the cursor CS designating ITEM 7. Then, if the down arrow button DB is depressed once while selection screen P7 is being displayed, the displayed screen is switched over to selection screen P6 with the cursor CS designating ITEM 6, and in this state, ITEM 6 can be selected by depressing the selection button SB once.

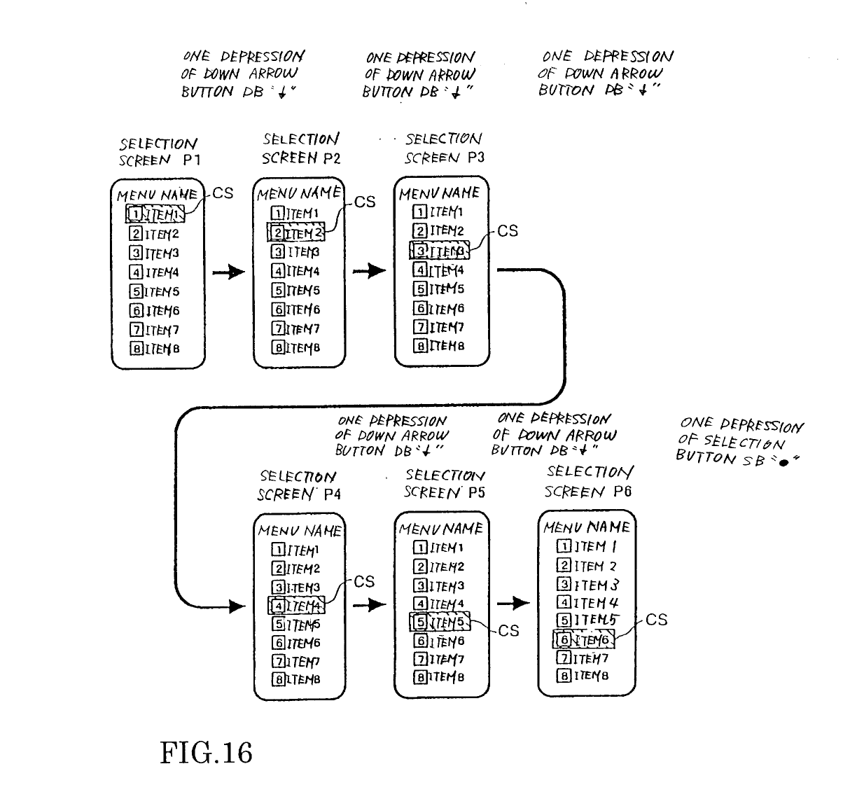

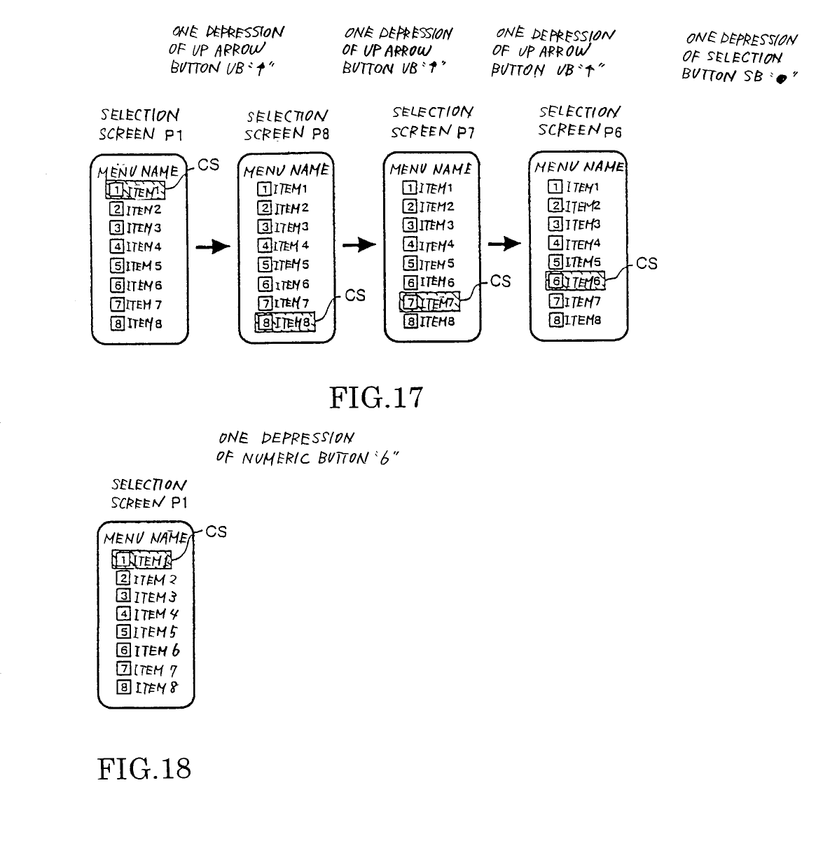

For selection of ITEM 6, the example of FIG. 9 requires three button depressions while the conventional approach of FIG. 16 requires five button depressions; thus, the example of FIG. 9 can dispense with or save two button depressions as compared to the conventional approach. Further, for selection of the same menu item, ITEM 6, the example of FIG. 10 requires two button depressions while the conventional approach of FIG. 17 requires three button depressions; thus, the example of FIG. 10 can save one button depression as compared to the conventional approach. Furthermore, for selection of the same menu item, ITEM 6, the example of FIG. 10 can save one button depression as compared to the example of FIG. 9. The user may select ITEM 6 using any desired one of the examples of FIGS. 9 and 10.

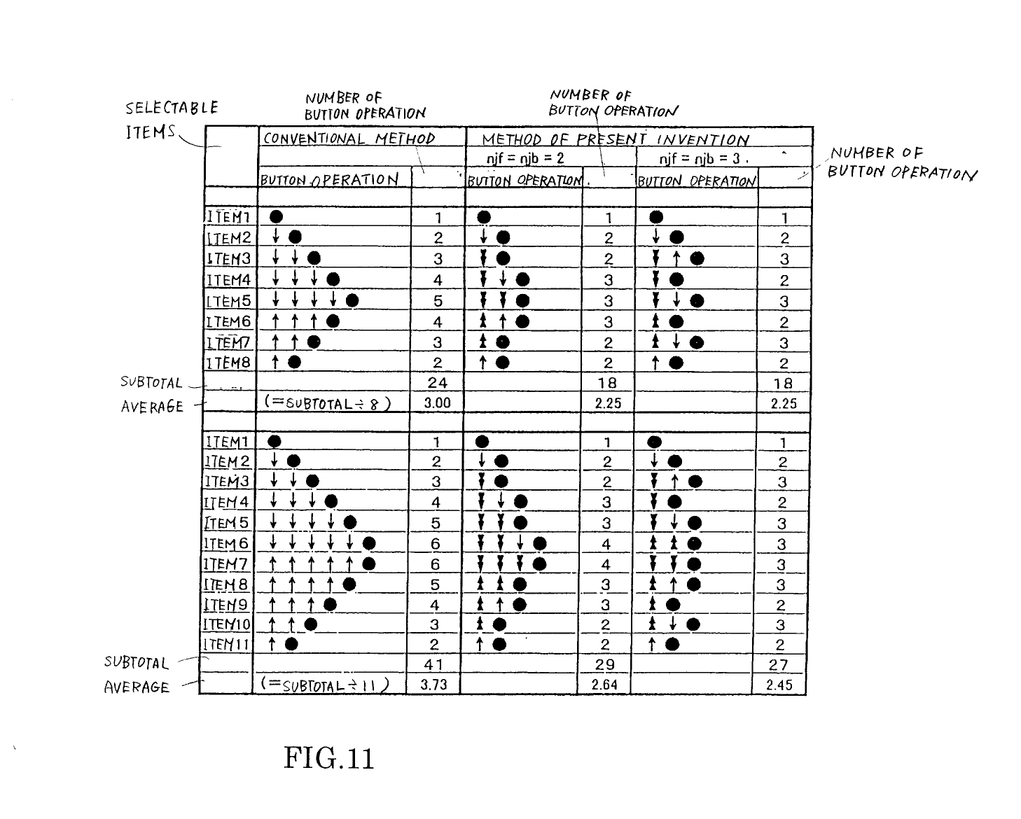

FIG. 11 is a diagram showing a comparison between the second embodiment of the menu item selection method of the present invention and the conventional menu item selection method in terms of a minimum number of button operations that are necessary for selection of each individual item in two different menus having eight and eleven selectable items (i.e., the first menu whose number of menu items N is “8”, and the second menu whose number of menu items N is “11”). The “conventional menu item selection method” in this case is the one as described earlier in relation to FIG. 16 or 17 where the cursor is moved using any of the down arrow button DB and up arrow button UB to designate a desired menu item and then the thus-designated desired menu item is selected by activation of the selection button SB. Further, the “second embodiment of the menu item selection method of the present invention” is the one as described earlier in relation to FIGS. 8 to 10 where the cursor is moved using any of the down and up arrow buttons DB and UB and the right arrow (forward jump) and left arrow (backward jump) buttons RB and LB to designate a desired menu item and then the thus-designated desired menu item is selected by activation of the selection button SB. In FIG. 11, the “second embodiment of the menu item selection method of the present invention” is shown in relation to two different cases where the numbers of jumped items njf and njb are both set to “2” and “3”.

In FIG. 11, whereas the average necessary number of button operations according to the conventional menu item selection method is “3” for the first menu showing 8 selectable items (N=8) and “3.73” for the second menu showing 11 selectable items (N=11), the average necessary number of button operations according to the second embodiment of the menu item selection method of the present invention is “2.25” for the first menu and “2.64” for the second menu in the case where the numbers of jumped items njf and njb are both set to “2”, and is “2.25” for the first menu and “2.45” for the second menu in the case where the numbers of jumped items njf and njb are both set to “3”. Thus, it can be seen that the second embodiment of the menu item selection method of the present invention can select a desired item with a smaller number of button operations.

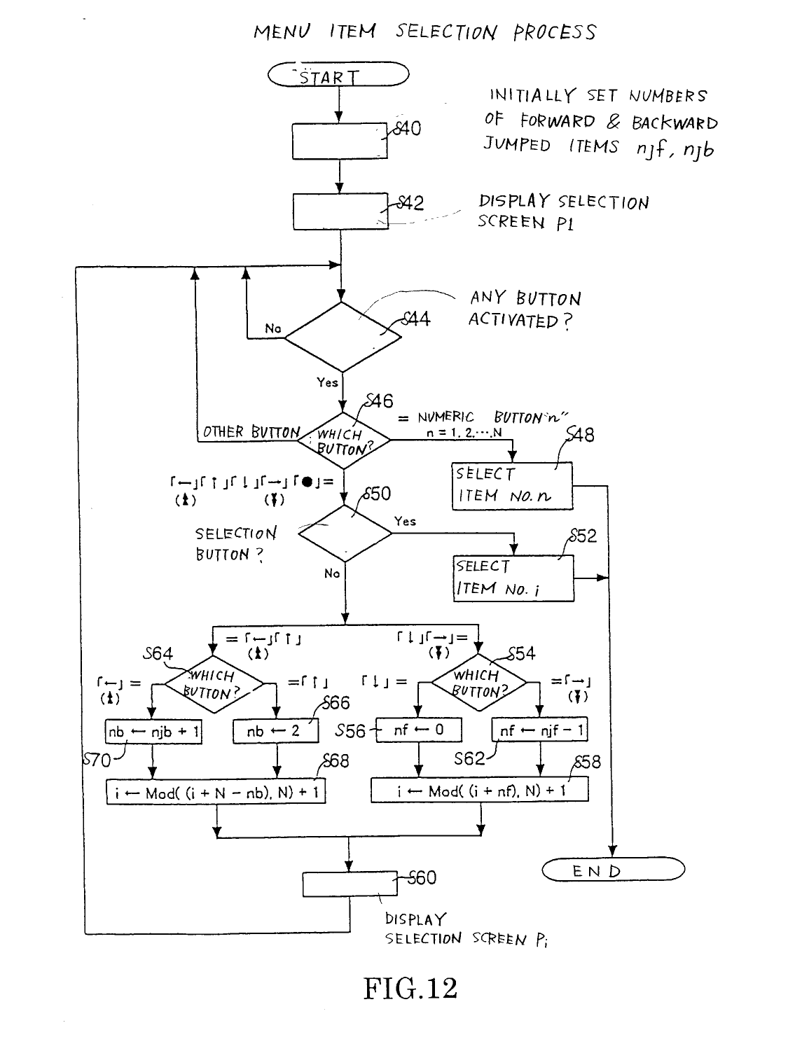

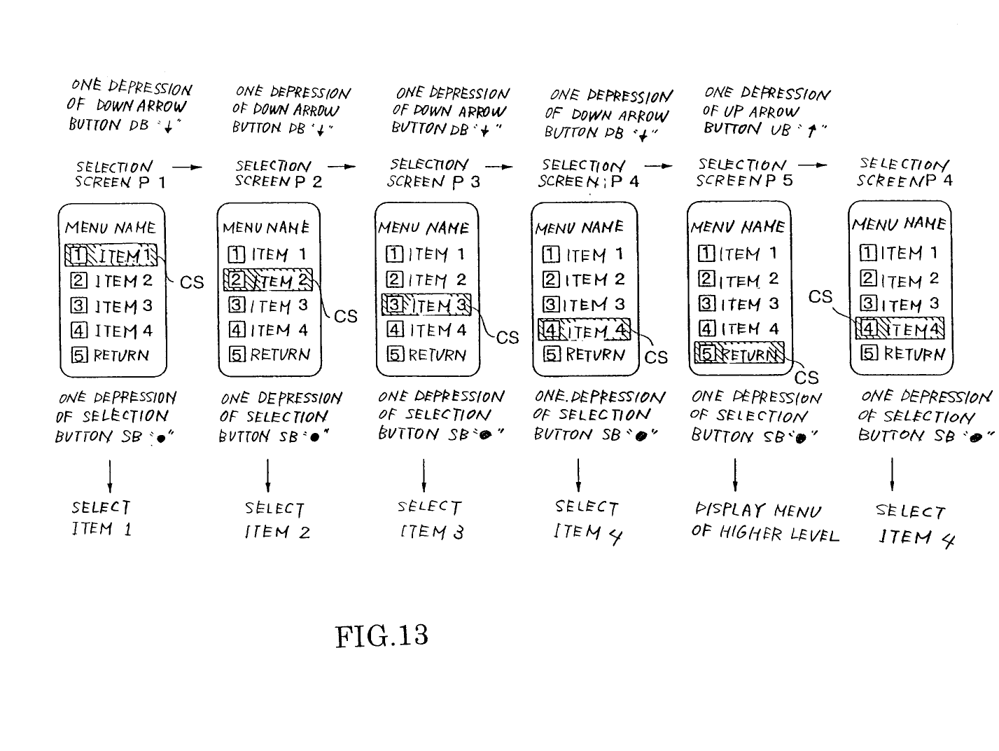

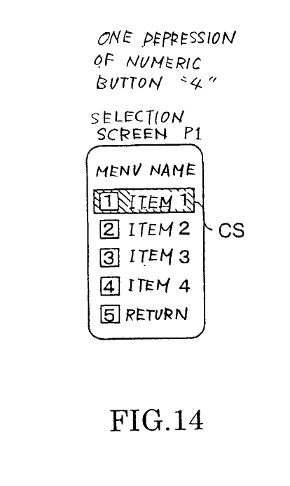

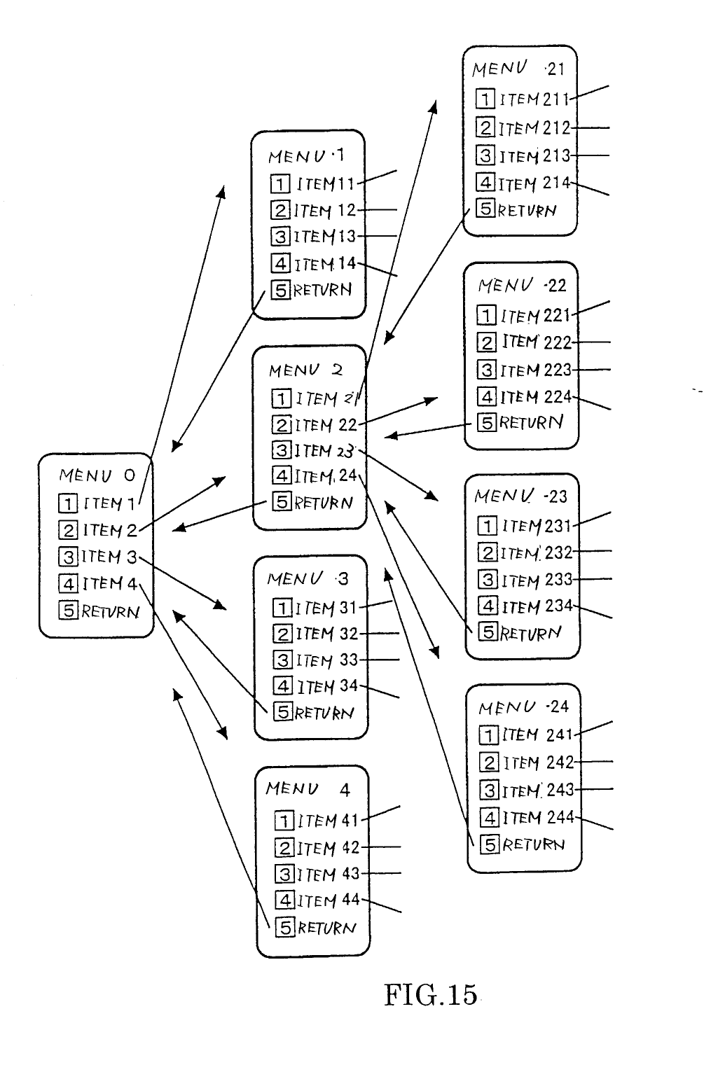

FIG. 12 is a flow chart showing an exemplary step sequence of the menu item selection process based on the second embodiment of the menu item selection method of the invention. This menu item selection process is started up in response to operation in a menu of a predetermined higher hierarchical level as noted earlier.

At step S40, the numbers of forward and backward jumped items njf and njb are set to user-desired initial values. Let it be assumed here that default values of the numbers of forward and backward jumped items njf and njb are both “2” and the numbers njf and njb can be set to any other values desired by the user, such as “3”.

At step S42, the item number i is set to “1”, and selection screen PI with the cursor CS designating ITEM 1 is displayed on the display section 22A′ as shown in FIG. 4. At next step S44, a determination is made as to whether there has been activated any one of the cursor-moving buttons. If answered in the negative (NO determination), the operation of step S44 is repeated until any one of the cursor-moving buttons is activated.

When any one of the cursor-moving buttons has been activated, an affirmative (YES) determination is made at step S44, so that the selection process goes to step S46 to determine which of the cursor-moving buttons has been activated. If the activated cursor-moving buttons is a numeric button n (n=1, 2, . . . N), the selection process moves to step S48 in order to select the item number n (ITEM of the number n). In this way, any desired menu item can be selected in accordance with activation of a corresponding one of the numeric buttons. Then, the menu item selection process is brought to an end.

If it is determined at step S46 that the activated cursor-moving button is one of the left arrow (backward jump) button LB, up arrow button, down arrow button DB and right arrow (forward jump) button RB and selection button SB, the selection process goes to step S50 in order to determine whether or not the activated cursor-moving button is the selection button SB. If answered in the affirmative at step S50, the item number i (ITEM of the number i) is selected at step S52. In this way, any desired menu item can be selected in accordance with activation of the selection button SB. For example, when step S52 is taken for the first time after step S42, ITEM 1 is selected. After step S52, the menu item selection process is brought to an end.

If it is determined at step S46 that the activated cursor-moving button is other than the numeric buttons n, left arrow (backward jump) button LB, up arrow button UB, down arrow button DB, right arrow (forward jump) button RB and selection button SB, the operations of steps S44 and S46 are repeated until any one of these buttons is activated.

If a negative (NO) determination is made at step S50, and if the activated button is one of the down arrow button DB and right arrow button RB, the selection process goes to step S54. At step S54, it is further determined which of the down arrow button DB and right arrow button RB the activated button is. If the activated button is the down arrow button DB as determined at step S54, the selection process goes to step S56 in order to set a value “0” as a control value nf.

At next step S58, a calculation result of “Mod ((i+nf), N)+1” is set as the item number i. Here, Mod ((i+nf), N) represents a remainder obtained when the integer “(i+nf)” is divided by the integer “N” (integral calculation). When step S58 is taken for the first time after step S42, the item number i is “1” (i=1), so that in the case where the menu has eight selectable items (N=8), Mod ((1+0), 8)+1=2 and thus the value “2” is set as the item number i. After that, selection screen Pi is displayed on the display section 22A′, at step S60; specifically, when “2” is set as the item number i at step S58 as noted above, selection screen P2 with the cursor CS designating ITEM 2 is displayed on the display section 22A′. This means that the cursor CS has moved from ITEM 1 to ITEM 2 in response to activation of the down arrow button DB.

If the activated button is the right arrow button RB as determined at step S54, the selection process branches to step S62 in order to set a value “njf−1 ” as the control value nf. For example, if njf=2, “1” is set as the control value nf. Then, at next step S58, a calculation result of “Mod ((i+nf), N)+1” is set as the item number i. When step S58 is taken for the first time after step S42, the item number i is “1” (i=1), so that in the case where the menu has eight selectable items (N=8), Mod ((1+1), 8)+1=3 and thus the value “3” is set as the item number i. After that, selection screen Pi is displayed on the display section 22A′, at step S60; specifically, when “3” is set as the item number i at step S58 as noted above, selection screen P3 with the cursor CS designating ITEM 3 is displayed on the display section 22A′. This means that the cursor CS has moved from ITEM 1 to ITEM 3 in response to activation of the right arrow button RB.

If a negative (NO) determination is made at step S50, and if the activated button is one of the up arrow button UB and left arrow button LB, the process goes to step S64. At step S64, it is further determined which of the up arrow button UB and left button LB the activated button is. If the activated button is the up arrow button UB as determined at step S64, the selection process goes to step S66 in order to set a value “2” as a control value nb.

At next step S68, a calculation result of “Mod ((i+N−nb), N)+1” is set as the item number i. When step S68 is taken for the first time after step S42, the item number i is “1” (i=1), so that in the case where the menu has eight selectable items (N=8), Mod ((1+8−2)+8)+1=8 and thus the value “8” is set as the item number 1. After that, selection screen Pi is displayed on the display section 22A′, at step S60; specifically, when “8” is set as the item number i at step S68 as noted above, selection screen P8 with the cursor CS designating ITEM 8 is displayed on the display section 22A′. This means that the cursor CS has moved from ITEM 1 to ITEM 8 in response to activation of the up arrow button UB.

If the activated button is the left arrow button LB as determined at step S64, the selection process branches to step S70 in order to set a value “njb+1” as the control value nb. For example, if njb 32 2, “3” is set as the control value nb. Then, at next step S68, a calculation result of “Mod ((i+N−nb), N)+1” is set as the item number 1. When step S68 is taken for the first time after step S42, the item number i is “1” (i=1), so that in the case where the menu has eight selectable items (N=8), Mod ((1+8−3), 8)+1=7 and thus the value “7” is set as the item number i. After that, selection screen Pi is displayed on the display section 22A′, at step S60; specifically, when “7” is set as the item number i at step S68 as noted above, selection screen P7 with the cursor CS designating ITEM 7 is displayed on the display section 22A′. This means that the cursor CS has moved from ITEM 1 to ITEM 7 in response to activation of the right arrow button RB.

After step S60, the selection process reverts to step S44 to determine whether there has been activated any one of the cursor-moving buttons on currently displayed selection screen Pi. With an affirmative answer at step S44, the operations at and after step S46 are carried out in the same manner as described earlier.

Namely, in the case where the numbers of jumped items njf and njb are both “2” (njf=njb=2) and the menu has eight selectable items (N=8), and if the right arrow button RB is depressed once while selection screen P7 with the cursor CS designating ITEM 7 is being displayed, a calculation result “Mod ((7+1), 8)+1=1” is obtained and thus the value “1” is set as the item number i, at step S58. As a consequence, selection screen P1 with the cursor CS designating ITEM 1 is displayed on the display section 22A′, at step 60; this means that the cursor CS has moved from ITEM 7 to ITEM 1 in response to activation of the right arrow button RB.

Further, if the down arrow button DB is depressed once while selection screen P8 with the cursor CS designating ITEM 8 is being displayed, a calculation result “Mod ((8+0), 8)+1=1” is obtained and thus the value “1” is set as the item number i, at step S58. As a consequence, selection screen P1 with the cursor CS designating ITEM 1 is displayed on the display section 22A′, at step 60; this means that the cursor CS has moved from ITEM 8 to ITEM 1 in response to activation of the down arrow button DB.

Furthermore, if the right arrow button RB, rather than the down arrow button DB, is depressed once while selection screen P8 is being displayed, a calculation result “Mod ((8+1), 8)+1=2” is obtained and thus the value “2” is set as the item number i, at step S58. As a consequence, selection screen P2 with the cursor CS designating ITEM 2 is displayed on the display section 22A′, at step 60; this means that the cursor CS has moved from ITEM 8 to ITEM 2 in response to activation of the right arrow button RB. Similarly, if the left arrow button LB is depressed once while selection screen P2 with the cursor CS designating ITEM 2 is being displayed, a calculation result “Mod ((2+8−3), 8)+1=8” is obtained and thus the value “8” is set as the item number i, at step S68. As a consequence, selection screen P8 with the cursor CS designating ITEM 8 is displayed on the display section 22A′, at step 60; this means that the cursor CS has moved from ITEM 2 to ITEM 8 in response to activation of the left arrow button LB.

Furthermore, if the up arrow button UB is depressed once while selection screen P1 with the cursor CS designating ITEM 1 is being displayed, a calculation result “Mod ((1+8−2 ), 8)+1=8” is obtained and thus the value “8” is set as the item number i, at step S68. As a consequence, selection screen P8 with the cursor CS designating ITEM 8 is displayed on the display section 22A′, at step 60; this means that the cursor CS has moved from ITEM 1 to ITEM 8 in response to activation of the up arrow button UB. Similarly, if the left arrow button LB, rather than the up arrow button UB, is depressed while selection screen P1 is being displayed, a calculation result “Mod ((1+8−3), 8)+1=7” is obtained and thus the value “7” is set as the item number i, at step S68. As a consequence, selection screen P7 with the cursor CS designating ITEM 7 is displayed on the display section 22A′, at step 60; this means that the cursor CS has moved from ITEM 1 to ITEM 7 in response to activation of the left arrow button LB.

In the menu item selection process having been described above with reference to FIG. 12, it is possible to perform such menu item selection as set forth in relation to FIGS. 8 to 11, and the user is allowed to readily select a desired menu item with a smaller number of button operations than in the conventional menu item selection method.

The second embodiment of the present invention may be modified variously as follows, rather than being limited to the above-described.

(1) Whereas the selectable menu items have been shown and described as arranged or displayed in order of increasing item numbers in the top-to-bottom direction (ITEM 1 to ITEM 8 (or ITEM 11)); they may be displayed in order of decreasing item numbers in the top-to-bottom direction (ITEM 8 (or ITEM 11) to ITEM 1). Alternatively, the selectable menu items may be arranged or displayed in order of increasing or decreasing item numbers in the left-to-right direction.

(2) Further, the selectable menu items (ITEM 1 to ITEM 8 (or ITEM 11)) may be arranged in a generally closed loop configuration, such as a ring-like configuration.

(3) Whereas the right and left arrow buttons have been described as also functioning as the forward and backward jump buttons, other suitable buttons may be assigned to perform the functions of the forward and backward jump buttons. If possible, dedicated forward and backward jump buttons may be provided on the body of the cellular phone.

(4) It should be appreciated that the second embodiment of the menu item selection method of the present invention having described above may be applied to other small-sized information terminal apparatus than cellular phones, such as game apparatus.

In summary, the present invention is characterized by displaying more than two menu items on the display section 22A′ along with the cursor for designating any one of the menu items; and selectively using one of a first operation mode where the cursor is moved one menu item per activation of a first operator and a second operation mode where the cursor is move to designate the menu item displayed a predetermined number nj (nj≧2) of menu items ahead of the menu item currently designated by the cursor. With such arrangements, the present invention can reduce the necessary number of operations of the operators and thus allows the user to select a desired menu item with simpler operation.

What is claimed is:

1. A menu item selection method for use with an information terminal apparatus including a display section and a selection button, said menu item selection method comprising:
a step of displaying a plurality of menu items on said display section;
a step of displaying a cursor on said display section in such a manner that said cursor sequentially designates individual ones of the menu items in a cyclic fashion;
a step of detecting whether said selection button has been activated while any one of the plurality of menu items is being designated by said cursor; and
a step of selecting the menu item being designated by said cursor, in response to detection, by said step of detecting, activation of said selection button.

2. A menu item selection method as claimed in claim 1 which further comprises a step of generating a sound each time said cursor designates one of the plurality of menu items.

3. A menu item selection method as claimed in claim 2 wherein, for each of the menu items by said step of generating, of the sound is generated with a delay of a predetermined time behind display start timing of said cursor for the menu item.

4. A menu-item selection method as claimed in claim 1 wherein said information terminal apparatus is a mobile phone.

5. A menu item selection method comprising:
a step of displaying first to Nth (N≧3) menu items on a display section in order of menu item numbers, as well as a cursor for designating any one of the menu items;
a first movement step of, each time a first operator is activated, moving said cursor, in a predetermined direction along an arrangement of said first to Nth menu items, to designate the menu item displayed next to the menu item currently designated by said cursor;
a second movement step of, each time a second operator is activated, moving said cursor, in said predetermined direction, to designate the menu item displayed a predetermined number nj (nj≧2) of menu items ahead of the menu item currently designated by said cursor;
a step of detecting whether a selection button has been activated while any one of said first to Nth menu items is being designated by said cursor; and
a step of selecting the menu item being designated by said cursor, in response to detection, by said step of detecting, activation of said selection button.

6. A menu item selection method as claimed in claim 5 wherein said predetermined direction is a direction from said first menu item toward said Nth menu item,
wherein when said first operator is activated while said cursor is designating said Nth menu item, said first movement step moves said cursor to designate said first menu item, and wherein when said second operator is activated while said cursor is designating any one of the menu items within a range from said Nth menu item to the menu item displayed a predetermined number k (k=nj−1) of menu items backward of said Nth menu item, said second movement step moves said cursor from said Nth menu item directly back to said first menu item so as to designate the menu item displayed the predetermined number nj of menu items ahead of the menu item being designated by said cursor.

7. A menu item selection method as claimed in claim 5 wherein said predetermined direction is a direction from said Nth menu item toward said first menu item,
wherein when said first operator is activated while said cursor is designating said first menu item, said first movement step moves said cursor to designate said Nth menu item, and
wherein when said second operator is activated while said cursor is designating any one of the menu items within a range from said first menu item to the menu item displayed a predetermined number k (k=nj−1) of menu items backward of said first menu item, said second movement step moves said cursor from said first menu item directly back to said Nth menu item so as to designate the menu item displayed the predetermined number nj of menu items ahead of the menu item being designated by said cursor.

8. An information terminal apparatus comprising:
a display section;
a display unit for displaying first to Nth (N≧3) menu items on said display section in order of menu item numbers, as well as a cursor for designating any one of the menu items;
first to fourth operators for controlling movement, on said display section, of said cursor;
a first movement section for, each time said first operator is activated, moving said cursor, in a first direction from said first menu item toward said Nth menu item, to designate the menu item next to the menu item currently designated by said cursor;
a second movement section for, each time said second operator is activated, moving said cursor, in said first direction, to designate the menu item displayed a predetermined number nj (nj≧2) of menu items ahead of the menu item currently designated by said cursor;
a third movement section for, each time said third operator is activated, moving said cursor, in a second direction from said Nth menu item toward said first menu item, to designate the menu item next to the menu item currently designated by said cursor;
a fourth movement section for, each time said fourth operator is activated, moving said cursor, in said second direction, to designate the menu item displayed the predetermined number nj of menu items ahead of the menu item currently designated by said cursor;
a selection operator for selecting a desired one of said first to Nth menu items;
a detection section for detecting whether said selection operator has been activated while any one of said first to Nth menu items is being designated by said cursor; and
a selection section for selecting the menu item being designated by said cursor, in response to detection, by said detection section, activation of said selection operator.

9. An information terminal apparatus as claimed in claim 8 wherein when said first operator is activated while said cursor is designating said Nth menu item, said first movement section moves said cursor to designate said first menu item,
wherein when said second operator is activated while said cursor is designating any one of the menu items within a range from said Nth menu item to the menu item displayed a predetermined number k (k=nj−1) of menu items backward of said Nth menu item, said second movement section moves said cursor from said Nth menu item directly back to said first menu item so as to designate the menu item displayed the predetermined number nj of menu items ahead of the menu item being designated by said cursor,
wherein when said third operator is activated while said cursor is designating said first menu item, said third movement section moves said cursor to designate said Nth menu item, and
wherein when said fourth operator is activated while said cursor is designating any one of the menu items within a range from said first menu item to the menu item displayed a predetermined number k (k=nj−1) of menu items backward of said first menu item, said fourth movement section moves said cursor from said first menu item directly back to said Nth menu item so as to designate the menu item displayed the predetermined number nj of menu items ahead of the menu item being designated by said cursor.

10. An information terminal apparatus as claimed in claim 8 wherein said first and third operators are provided for controlling vertical movement of said cursor in an operation mode different from a menu item selection mode where one of said first to Nth menu items being designated by said cursor is selected in response to activation of said selection operator, and
wherein said second and fourth operators are provided for controlling horizontal movement of said cursor in the operation mode different from the menu item selection mode.

11. An information terminal apparatus as claimed in claim 9 wherein said first and third operators are provided for controlling vertical movement of said cursor in an operation mode different from a menu item selection mode where one of said first to Nth menu items being designated by said cursor is selected in response to activation of said selection operator, and
wherein said second and fourth operators are provided for controlling horizontal movement of said cursor in the operation mode different from the menu item selection mode.

12. An information terminal apparatus as recited in claim 8 wherein said information terminal apparatus is a mobile phone.
